(19) United States
(12) Patent Application Publication
(10) Pub. No.: US 2024/0244706 A1
(43) Pub. Date: Jul. 18, 2024

(54) SMALL DATA TRANSMISSION

(71) Applicant: Nokia Technologies Oy, Espoo (FI)

(72) Inventors: Jussi-Pekka KOSKINEN, Oulu (FI); Samuli Heikki TURTINEN, Oulu (FI); Ahlem KHLASS, Massy (FR)

(21) Appl. No.: 18/574,201

(22) PCT Filed: May 16, 2022
(86) PCT No.: PCT/EP2022/063117

§ 371 Date: Dec. 26, 2023

Related U.S. Application Data
(60) Provisional application No. 63/216,132, filed on Jun. 29, 2021.

(51) Int. Cl. H04W 76/27; H04W 76/11

(52) U.S. Cl. CPC H04W 76/27; H04W 76/11

(57) ABSTRACT

Embodiments of the present disclosure relate to methods, devices, apparatuses, and computer readable medium for small data transmission (SDT). The method comprises in accordance with a determination that a first condition related to Small Data Transmission (SDT) is met, determining a target identifier associated with an inactive state of the first device; and transmitting, to the second device, a first message for the SDT comprising the target identifier. By using an I-RNTI determined based on the SDT type, which may be the short I-RNTI or a new I-RNTI even shorter than the short I-RNTI, bits can be saved and used for UL data that can be transmitted while respecting a maximum SDT data threshold configured by the network device.

### FIELD

Embodiments of the present disclosure generally relate to the field of telecommunication and in particular, to devices, methods, apparatus and computer readable storage media of small data transmission (SDT).

### BACKGROUND

As communication technologies evolve to the fifth-generation new radio, which is also referred to as 5G NR, a new Radio Resource Control (RRC) state, i.e., RRC_INACTIVE state, has been introduced to adapt to new application scenarios and service characteristics. The RRC_INACTIVE state allows the terminal device to operate in a low power consumption manner, but transmission and/or reception of infrequent and small data is permitted, for example, by using the SDT.

When a terminal device (e.g., UE) is in RRC_INACTIVE state, the radio connection is only suspended while the core network connectivity is maintained active. That is, the UE is kept in Connection Management (CM)-CONNECTED state. A UE Access Stratum (AS) context (referred to as UE Inactive AS context) is stored at both the UE and RAN sides for a fast resume of a suspended connection, including the latest radio bearer configuration used for data or signaling transmission, and importantly security keys and algorithms for integrity protection and ciphering in the radio interface. Based on this retained information, the terminal device is able to resume the radio connection with a much lower delay and associated signaling overhead as compared to a terminal device in RRC IDLE state that needs to establish a new connection to both the radio and core network.

### SUMMARY

In general, example embodiments of the present disclosure provide a solution for small data transmission. Embodiments that do not fall under the scope of the claims, if any, are to be interpreted as examples useful for understanding various embodiments of the disclosure.

In a first aspect, there is provided a first device. The first device comprises: at least one processor; and at least one memory including computer program codes. The at least one memory and the computer program codes are configured to, with the at least one processor, cause the first device to: in accordance with a determination that a first condition related to Small Data Transmission (SDT) is met, determine a target identifier associated with an inactive state of the first device; and transmit, to the second device, a first message for the SDT comprising the target identifier in the inactive state.

In a second aspect, there is provided a second device. The second device comprises: at least one processor; and at least one memory including computer program codes. The at least one memory and the computer program codes are configured to, with the at least one processor, cause the second device to: receive, from a first device, a first message for Small Data Transmission (SDT) comprising a target identifier associated with an inactive state of the first device, the target identifier determined by the first device in accordance with a first condition related to SDT being met; and identify the first device based on the target identifier.

In a third aspect, there is provided a method. The method comprises: in accordance with a determination that a first condition related to Small Data Transmission (SDT) is met, determining, at a first device, a target identifier associated with an inactive state of the first device; and transmitting, to the second device, a first message for the SDT comprising the target identifier in the inactive state.

In a fourth aspect, there is provided a method. The method comprises: receiving, at a second device and from a first device, a first message for Small Data Transmission (SDT) comprising a target identifier associated with an inactive state of the first device, the target identifier determined by the first device in accordance with a first condition related to SDT being met; and identifying the first device based on the target identifier.

In a fifth aspect, there is provided a first apparatus. The first apparatus comprises: means for in accordance with a determination that a first condition related to Small Data Transmission (SDT) is met, determining a target identifier associated with an inactive state of the first device; and means for transmitting, to the second device, a first message for the SDT comprising the target identifier in the inactive state.

In a sixth aspect, there is provided a second apparatus. The second apparatus comprises: means for receiving, from a first device, a first message for Small Data Transmission (SDT) comprising a target identifier associated with an inactive state of the first device, the target identifier determined by the first device in accordance with a first condition related to SDT being met; and means for identifying the first device based on the target identifier.

In a seventh aspect, there is provided a non-transitory computer readable medium. The non-transitory computer readable medium comprises program instructions for causing an apparatus to perform the method according to the third aspect.

In an eighth aspect, there is provided a non-transitory computer readable medium. The non-transitory computer readable medium comprises program instructions for causing an apparatus to perform the method according to the fourth aspect

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication network in which example embodiments of the present disclosure can be implemented;

FIG. 2 illustrates a schematic diagram of the UL MAC Protocol Data Unit (PDU) format for SDT carrying the RRCResumeRequest message and the UL SDT payload according to some example embodiments of the present disclosure;

FIG. 3 shows a signaling chart illustrating a process of SDT procedure according to some example embodiments of the present disclosure;

FIG. 4A shows a signaling chart illustrating a process of 4-step RACH-based SDT procedure 401 according to some example embodiments of the present disclosure;

FIG. 4B shows a signaling chart illustrating a process of 2-step RACH-based SDT procedure according to some example embodiments of the present disclosure;

FIG. 5 shows a signaling chart illustrating a process of CG-based SDT procedure according to some example embodiments of the present disclosure;

FIG. 6 illustrates a flowchart of an example method for small data transmission implemented at a first device according to example embodiments of the present disclosure;

FIG. 7 illustrates a flowchart of an example method for small data transmission implemented at a second device according to example embodiments of the present disclosure;

FIG. 8 illustrates a simplified block diagram of an apparatus that is suitable for implementing example embodiments of the present disclosure; and

FIG. 9 illustrates a block diagram of an example computer readable medium in accordance with example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a Remote Radio Unit (RRU), a radio header (RH), a remote radio head (RRH), a relay, an Integrated and Access Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. The network device is allowed to be defined as part of a gNB such as for example in CU/DU split in which case the network device is defined to be either a gNB-CU or a gNB-DU.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

The network device may instruct the terminal device to enter RRC_INACTIVE state from RRC_CONNECTED state by sending an RRCRelease message. Hence, in this situation, the network device is the last serving network device, which is also referred to as an anchor node where the UE AS context is stored. The RRCRelease message includes a SuspendConfig parameter which includes a full Inactive Radio Network Temporary Identifier (I-RNTI) and a short I-RNTI for identifying both the last serving network device and the UE. The full I-RNTI has a size of 40 bits, while the short I-RNTI has a size of 24 bits.

The network device may inform the UE of whether the full I-RNTI or the short I-RNTI is to be used for resuming the radio connection in system information, such as, the System Information Block #1 (SIB1). Further, the network device uses only the full I I-RNTI as part of PagingUE-Identity within the paging message. For example, if a flag useFullResumeID is present in SIB1, it indicates that the full I-RNTI is to be used by the terminal device. Otherwise, if the flag useFullResumeID is absent from SIB1, it indicates that the short I-RNTI is to be used by the terminal device. When the UE initiates SDT with the network device, the UE transmits an RRCResumeRequest message which includes the I-RNTI as indicated by the network device for identifying itself and network device where the UE context is stored (I-RNTI includes both the UE and the network IDs).

For CG-SDT, the base station preconfigures resources for uplink (UL) data to be transmitted via the SDT. The terminal device may perform subsequent UL or DL data transmissions after an initial SDT without transitioning to RRC_CONNECTED state. The SDT can be performed based on various modes, such as, a configured grant (CG) mode, a random access channel (RACH) mode which further includes a 4-step RACH and a 2-step RACH. For the CG-based SDT, a UE in RRC_CONNECTED state may receive a CG type1 configuration that indicates the specific pre-configured PUSCH resources to be used for UL data transmission in RRC_INACTIVE state as long as the timing alignment is valid. For the 4-step RACH-based SDT, user plane (UP) data is transmitted in MSG3, i.e., a small payload is multiplexed with e.g. a RRC connection resume request. For the 2-step RACH-based SDT, user plane (UP) data is transmitted in MSGA on the PUSCH resources that are pre-configured by the network device and broadcasted in System Information with associated physical transmission parameters.

Once the SDT mode is selected, the SDT payload is multiplexed with the RRCResumeRequest message which may include the following information:
ResumeID, which corresponds to the I-RNTI configured by the network device when the RRC connection was suspended. Based on the presence or absence of the flag “use FullResumeID” in SIB1, the network device instructs the UE to either use the full I-RNTI (and an RRCResumeRequest1 message) or the short I-RNTI (and an RRCResumeRequest message).
ResumeMAC-I, which is an authentication token generated using the stored security key for RRC integrity protection
ResumeCause, which provides the resume cause for the RRC connection resume request as provided by the upper layers or RRC.

The RRCResumeRequest1 message including the full I-RNTI has a size of 64 bits, while a smaller RRCResumeRequest message including the short I-RNTI has a size of 48 bits.

There may be a need for the network device to broadcast the flag use FullResumeID in system information. However, using the longer version of the RRCResumeRequest message increases the message space, resulting in not that much SDT payload size (belonging to SRB or DRB configured for SDT) can be included in the initial SDT transmission.

According to the embodiments of the present disclosure, there is provided a solution for enhanced SDT. With the solution, the terminal device may determine whether to use the full I-RNTI or the short I-RNTI when request for resuming the radio connection, even in a case of the full I-RNTI being indicated in the system information by the network device. In this way, the payload size of the RRCResumeRequest message can be reduced, so that more bits can be provided for UL data. This is particularly beneficial for the SDT operation where the payload size of the SDT that can be transmitted is limited by a maximum data volume threshold configured by the network device.

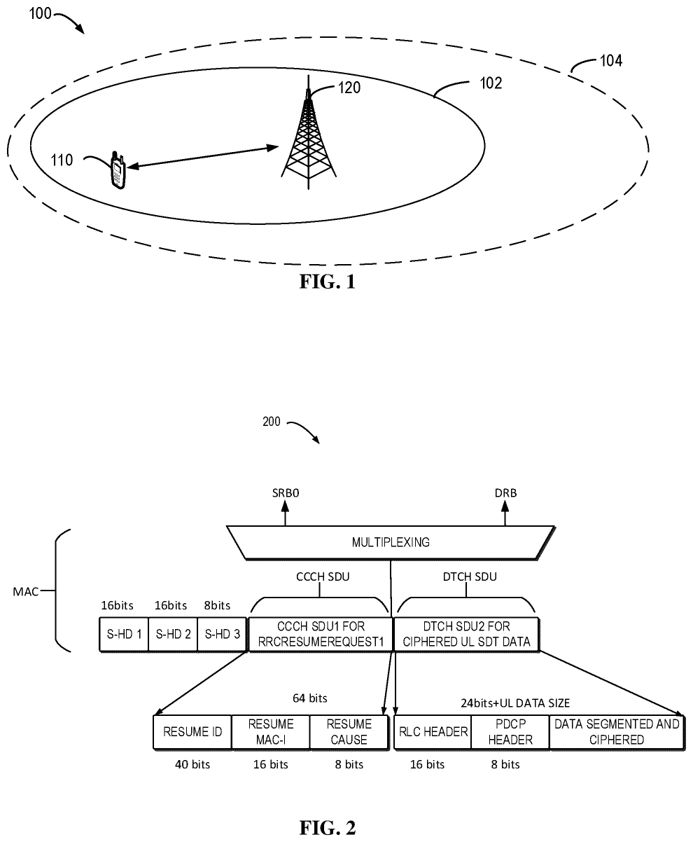

FIG. 1 illustrates an example communication network 100 in which example embodiments of the present disclosure can be implemented. As shown in FIG. 1, the communication network 100 includes a first device 110 and a second device 120.

The first device 110 (hereinafter may also be referred to as a terminal device 110 or a UE 110) is located within a cell 102 of the second device 120 as well as a RNA 104. The first device 110 may communicate with the second device 120. In some example embodiments, a link from the second device 120 to the first device 110 is referred to as a downlink (DL), while a link from the first device 110 to the second device 120 is referred to as an uplink (UL). In DL, the second device 120 is a transmitting (TX) device (or a transmitter) and the first device 110 is a receiving (RX) device (or a receiver). In UL, the first device 110 is a TX device (or a transmitter) and the second device 120 is a RX device (or a receiver).

The second device 120 (hereinafter may also be referred to as a network device 120 or a gNB 120) provides the cell 102 and serves the first device 110. The second device 120 may configure a data size threshold for the first device 110 to determine whether to transmit data via the SDT procedure. If a size of the data is smaller than the data size threshold (e.g., 1000 bits), the first device 110 may determine to transmit the data via the SDT. Otherwise, the terminal device may not use SDT for transmitting the data in RRC_INACTIVE state.

As discussed above, the second device 120 may command the terminal device 110 to transition from RRC_CONNECTED state to RRC_INACTIVE state by sending an RRCRelease with a SuspendConfig. The SuspendConfig may include both full and short I-RNTIs. When the RRC connection is suspended, the second device 120 may transmit an indication to the first device 110 to indicate which of the I-RNTIs is to be used for a resume identifier and which version of RRC connection resume requests should be used. For example, a flag useFullResumeID in SIB1 may be used for such an indication. If the flag useFullResumeID is present in the SIB 1, the first device 110 may determine to use the full I-RNTI and RRCResumeRequest1 for resuming connection. Otherwise, if the flag use FullResumeID is absent from the SIB 1, the first device 110 may determine to use short I-RNTI and RRCResumeRequest for resuming connection.

The first device 110 in RRC-INACTIVE state may initiate the SDT with a RRC connection resume request. The SDT may be performed based on the RACH procedure or CG procedure. For the CG-based SDT, the second device 120 may transmit a CG type1 configuration that indicates the specific pre-configured PUSCH resources for UL data transmission in RRC_INACTIVE state. Likewise, for the RACH-based SDT, the second device 120 may preconfigure the PUSCH resources and broadcasted in System Information with associated physical transmission parameters. In addition, the payload of the SDT is limited by a SDT data threshold configured by the second device 120.

FIG. 2 illustrates a schematic diagram of the UL MAC Protocol Data Unit (PDU) format for SDT carrying the RRCResumeRequest message and the UL SDT payload according to some example embodiments of the present disclosure. As shown in FIG. 2, RRCResumeRequest1 has a size of 64 bits with a 40-bit Resume ID field for the full I-RNTI. In addition, the RRCResumeRequest message has a size of 48 bits with a 24-bit Resume ID for the short I-RNTI. Thus, the version of RRC connection resume request may change the message space and may cause not that much SDT payload size (belonging to SRB or DRB configured for SDT) can be included in the initial SDT.

It is to be understood that the number of devices and their connections shown in FIG. 1 are only for the purpose of illustration without suggesting any limitation. The communication network 100 may include any suitable number of terminal devices adapted for implementing embodiments of the present disclosure. Although not shown, it would be appreciated that one or more additional devices may be located in the cell 102 and RNA 104, and one or more additional cells may be deployed in the environment 100.

Only for ease of discussion, the first device 110 is illustrated as a UE, and the second device 120 is illustrated as a base station. It is to be understood that UE and base station are only example implementations of the first device 110 and the second device 120 respectively, without suggesting any limitation as to the scope of the present application. Any other suitable implementations are possible as well.

Depending on the communication technologies, the network 100 may be a Code Division Multiple Access (CDMA) network, a Time Division Multiple Address (TDMA) network, a Frequency Division Multiple Access (FDMA) network, an Orthogonal Frequency-Division Multiple Access (OFDMA) network, a Single Carrier-Frequency Division Multiple Access (SC-FDMA) network or any others. Communications discussed in the network 100 may conform to any suitable standards including, but not limited to, New Radio Access (NR), Long Term Evolution (LTE), LTE-Evolution, LTE-Advanced (LTE-A), Wideband Code Division Multiple Access (WCDMA), Code Division Multiple Access (CDMA), cdma2000, and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols. The techniques described herein may be used for the wireless networks and radio technologies mentioned above as well as other wireless networks and radio technologies. For clarity, certain aspects of the techniques are described below for NR, and the NR terminology is used in much of the description below.

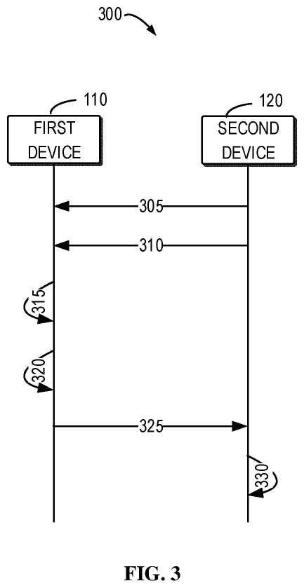

Principle and implementations of the present disclosure will be described in detail below with reference to FIG. 3. FIG. 3 shows a signaling chart illustrating a process of small data transmission procedure according to some example embodiments of the present disclosure. For the purpose of discussion, the process 300 will be described with reference to FIG. 1. The process 300 may involve the first device 110 and the second device 120.

The second device 120 may preconfigure resources to the first device 110 for data transmissions via the SDT. For example, a first set of resources may be configured for the RA-based SDT mode, and a second set of resources may be configured for the CG-based SDT mode. The first device 110, when operating in the RRC_CONNECTED mode, may select one of the SDT modes and corresponding resources for transmission of data.

As shown in FIG. 3, the second device 120 may transmit 305, to the first device 110, a RRC Release message. The RRC Release message may comprise a SuspendConfig parameter which includes both the full and short I-RNTIs.

In some example embodiments, the second device 120 may transmit 310 an indication of a first identifier associated with RRC_INACTIVE STATE to be used for resuming connection or for SDT data transfer. The indication may comprise a field in a SIB from the second device 120, and the field indicates the usage of the first identifier. By way of example, the field may be the flag “useFullResumeID” in SIB. The presence of the flag “usefullResumeID” may indicate the full-RNTI is to be used for resuming connection, and the absence of the flag may indicate the short-RNTI is to be used for resuming connection. It should be understood that any other indication from the network is also applicable to the example embodiments. Thus, the second device 120 may indicate, by transmitting the indication, to the first device 110 that full-RNTI should be used. In some examples, first identifier is the full-RNTI. However, according to some embodiments herein, the first device 110 may use a target identifier for the SDT if first condition is met. In some examples, the target identifier is different than the first identifier. Thus, for example, the target identifier may sometimes be an identifier shorter than the full-RNTI, such as short-RNTI or even a shorter identifier than the short-RNTI.

Upon receipt of the RRC Release message, the first device 110 may transition from RRC_CONNECTED STATE to RRC_INACTIVE STATE (or the first device 110 remains in RRC_INACTIVE in case the RRC Release message is received during the SDT procedure. In this case, the first device 110 does not go to RRC_CONNECTED). When operating in RRC_INACTIVE STATE, the first device 110 may attempt to transmit data via the SDT. The first device 110 determines 315 whether a first condition related to SDT is met.

The first condition may be configured or specified for determining whether to shorten the I-RNTI. From the perspective of the second device 120, the shortened I-RNTI should uniquely identify the terminal devices (and network device where the UE context is located) within the cell 102 or RNA 104, which will be discussed in details below.

If the first condition is met, the first device 110 determines 320 a target identifier associated with an inactive state of the first device. The target identifier may be one of a full Inactive Radio Network Temporary Identifier (I-RNTI), a short I-RNTI or an identifier (e.g. I-RNTI) shorter than the short I-RNTI.

The first condition may comprise one or more criterion. In one example, the first condition may comprise the type of the SDT to be performed being the CG-based SDT. In some example embodiments, if the type of the SDT to be performed with the second device 120 is the CG-based SDT, the first device 110 may use the short I-RNTI to perform CG-based SDT regardless of the indication from the second device 120 of the full I-RNTI to be used for resuming RRC connection, for example, a presence of the flag “use FullResumeID” flag in SIB1. In this case, the RRCResumeRequest, rather than the RRCResumeRequest1, should be used for carrying the short I-RNTI. Regardless herein may mean that even if “useFullResumeID” is present (i.e. is set true) in the SIB1, the first device 110 may use a different identifier than the full I-RNTI if the first condition is met. It is noted that first condition may be different in in different embodiments. Said different identifier may be, for example, short I-RNTI or an identifier shorter than the short I-RNTI.

In some example embodiments, if the type of the SDT to be performed with the second device 120 is the CG-based SDT, the first device 110 may use a new I-RNTI that is defined for the CG-based SDT and is shorter than the short I-RNTI. Since the second device 120 only configures CG-SDT resources for a certain number of terminal devices, the new I-RNTI even shortened can still be used for identifying the first device 110. In this case, a new RRC message may be used for carrying the new I-RNTI.

Likewise, the first condition may comprise the type of the SDT to be performed being one of the following a 4-step Random Access Channel (RACH) based SDT, and the first message comprising a MSG3, a 2-step Random Access Channel (RACH) based SDT, and the first message comprising a MSGA. In this case, the first device 110 may determine that I-RNTI can be shortened to be the short I-RNTI or an even shorter I-RNTI. In this case the RRC message may be used for carrying the short I-RNTI.

In some example embodiments, if the type of the SDT to be performed with the second device 120 is the RACH-based SDT, the first device 110 may use a new I-RNTI that is defined and/or configured for the RACH-based SDT and is shorter than the short I-RNTI. In this case, a new RRC message may be used for carrying the new I-RNTI.

In some example embodiments, the first condition may comprise the SDT to be performed on a cell provided by a last serving network device or the same cell or RNA where the RRC connection was suspended with RRC Release. This condition may be applied as an alternative or in addition to the type of SDT. I.e. in some embodiment, the first condition may be met if type of SDT equals to a certain type such as CG-based SDT. In another embodiment, the first condition may be met if SDT is to be performed on a cell provided by a last serving network device or the same cell where the RRC connection was suspended with RRC Release. In some embodiments, both of these need to be fulfilled in order to meet the first condition. Additionally or alternatively, the condition may comprise the SDT to be performed on RNA where the RRC connection was suspended. Due to a limited number of terminal devices in the same cell or RNA, the I-RNTI can be shortened to be the short I-RNTI or an even shorter I-RNTI, which will not affect the uniquely identification of the terminal device and network device. In this case, the first device 110 may use RRCResumeRequest for carrying the short I-RNTI or a new RRCResumeRequest for carrying the shorter I-RNTI. Therefore, the first condition may be met if a type of SDT equals to a certain type of SDT (e.g. CG-based SDT), the SDT is to be performed on a cell provided by a last serving network device, the SDT is to be performed on the same cell where the RRC connection was suspended with RRC Release and/or the SDT is to be performed on RNA where the RRC connection was suspended with RRC Release.

In some example embodiments, the first condition may comprise the SDT to be performed on a cell which provides for the first device with a RRC Release with suspend.

In some example embodiments, the first condition comprises the SDT to be performed on a cell which commands the first device to transition to RRC_INACTIVE state. In this case, if the first condition is met, the target identifier may be determined to be a short I-RNTI, or an I-RNTI shorter than the short I-RNTI.

In some example embodiments, the first condition may comprise one of the following:
the SDT to be performed on a first cell other than a second cell commands the first device 110 to transition to RRC_INACTIVE, or
a type of the SDT to be performed being different from the CG-based SDT
   In the above cases, if the first condition is met, the target identifier may be determined to be the full I-RNTI.

In one example, first device 110 may be suspended (i.e. set as inactive) on a certain cell. The first device 110 may be configured with both short and long I-RNTIs. The first device 110 may attempt SDT on said certain cell by using short I-RNTI (or even shorter I-RNTI). I.e. the full I-RNTI may not be needed as the cell is the same where the RRC connection of the first device 110 was suspended. Thus, the second device 120 may identify the first device 110 even with the shorter identifier. Such solution may work for different types of SDTs. It is again noted that the short I-RNTI or even shorter I-RNTI may be used in this example even if the second device 120 requests full I-RNTI to be used (e.g. by broadcasting the flag “useFullResumeID” in SIB1).

In some example embodiments, the first condition may further comprise a third message received from the second device 120 indicating the target identifier other than a full I-RNTI configured for the SDT. In this way, the second device 120 could configure in the RRCRelease message suspending the first device 110 (or in SIB) whether the Short I-RNTI shall be used by the first device 110.

In some example embodiments, the first condition may further comprise a fourth message received from the second device 120 indicating a field in a SIB to be ignored in determining the target identifier, and the field indicates a full I-RNTI to be used for the SDT. In this way, the second device 120 could configure whether the first device 120 should respect the flag “useFullResumeID” in the SIB1.

In some example embodiments, the first device 110 may receive, from the second device 120, a second message comprising information for determining the target identifier. For example, the information for determining the target identifier may indicate a first identifier (e.g., the full I-RNTI, the short I-RNTI or the like) based on which the target identifier is determined.

The information for determining the target identifier further indicates a rule for determining the target identifier from the first identifier. By way of example, the information for determining the target identifier may indicate a configuration of the target identifier. By way of another example, the information may indicate how many and/or which bits from the first I-RNTI the first device 110 should use for the CG-SDT, such as, x number of right most bits or y number of left most bits, etc. The number of bits may be from zero to a max number of full I-RNTI bits.

Upon determining the target identifier, the first device 110 transmits 325 a first message for the SDT comprising the target identifier to the second device 120. As discussed above, the first message comprises one of an RRCResumeRequest, a RRCResumeRequest1, or a further RRCResumeRequest for carrying an I-RNTI shorter than a short I-RNTI.

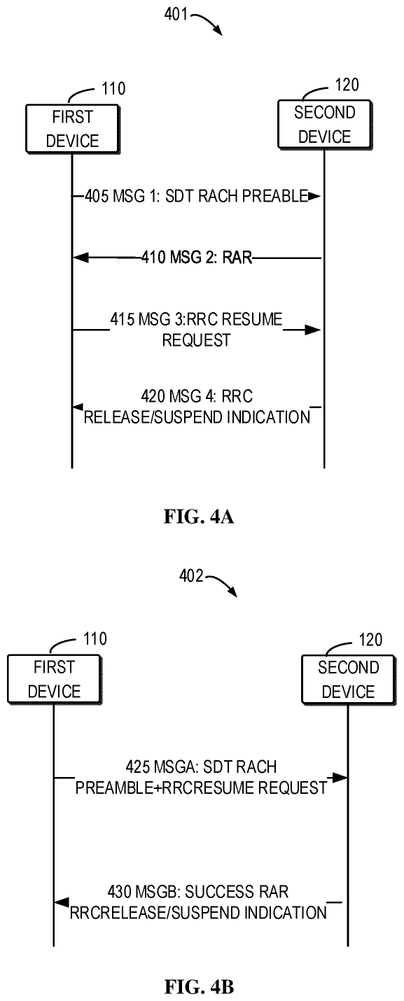

FIG. 4A shows a signaling chart illustrating a process of 4-step RACH-based SDT procedure 401 according to some example embodiments of the present disclosure. As shown in FIG. 4A, the first device 110 transmits 405 the SDT RACH preamble in MSG1 to the second device 120. The second device 120 transmits 410 a RA response to the first device 110. The first device 110 then determines the target identifier and then transmit 415 the RRCResumeRequest with the target identifier in MSG3. In some example embodiments, the MSG3 may further comprise UL data, for example, UP data. Hence, the payload is multiplexed with the RRCResumeRequest. The second device 120 may then transmit 420 the RRC release message with or without suspend indication in MSG4. In some example embodiments, the MSG4 may further comprise DL data.

FIG. 4B shows a signaling chart illustrating a process of 2-step RACH-based SDT procedure 402 according to some example embodiments of the present disclosure. In the example shown in FIG. 4B, the first device 110 determines the target identifier based on the type of 2-step RACH SDT. As shown in FIG. 4B, the first device 110 transmits 425 the SDT RACH preamble and RRCResumeRequest with the target identifier in MSGA to the second device 120. The second device 120 transmits 430 a RA response and the RRC release message with suspend indication in MSGB. In some example embodiments, the MSGA may further comprise UL data, for example, UP data. In some example embodiments, the MSGB may further comprise DL data.

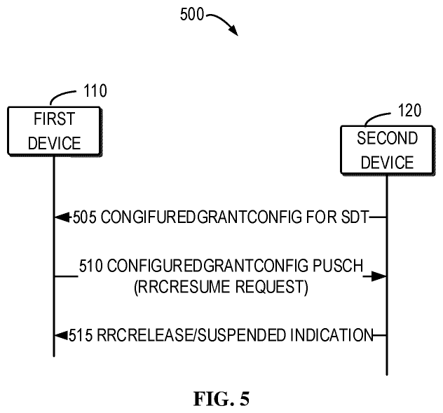

FIG. 5 shows a signaling chart illustrating a process of CG-based SDT procedure 500 according to some example embodiments of the present disclosure. When the first device 110 in RRC_CONNECTED state, the second device 120 may transmit 505 a ConfiguredGrantConfig for SDT. The first device 110 then enters RRC_INACTIVE state. the first device 110 may transmit 510 the RRCResumeRequest on the CG PUSCH. In some example embodiments, the first device 110 may further comprise UL data. The second device 120 may transmit 515 the RRC release message with suspend indication. In some example embodiments, the second device may further transmit DL data.

It should be understood that the steps and related functions described in process 200 are in no absolute chronological order, and some of the steps may be performed simultaneously or in an order differing from the given one. Other functions can also be executed between the steps or within the steps. Some of the steps can also be left out or replaced with a corresponding step. The present disclosure is not limited in this regard.

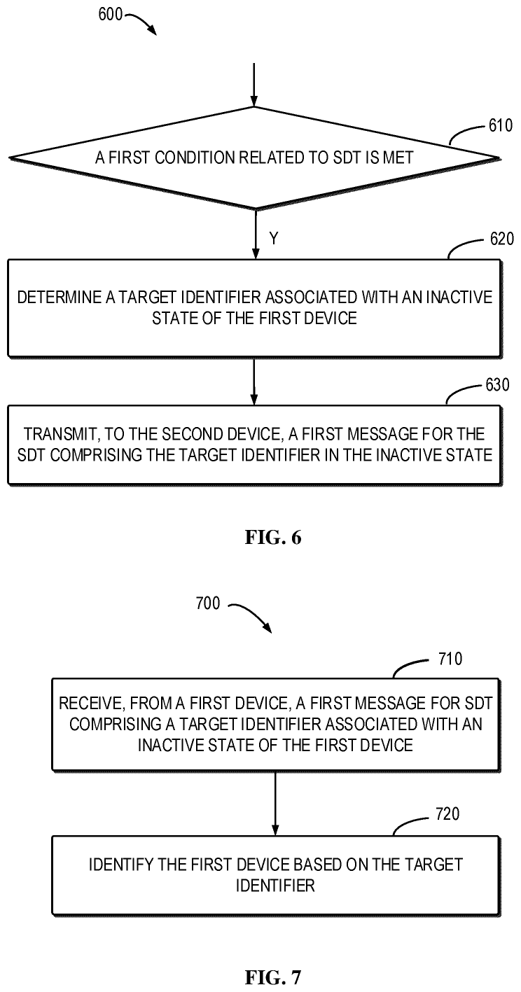

Corresponding to the process described in connection with FIG. 2, embodiments of the present disclosure provide a solution for small data transmission involving a terminal device and a network device. These methods will be described below with reference to FIGS. 6-7.

FIG. 6 illustrates a flowchart of a method 600 for small data transmission implemented at a terminal device according to example embodiments of the present disclosure. The method 600 can be implemented at the first device 110 shown in FIG. 1. For the purpose of discussion, the method 600 will be described with reference to FIG. 1. It is to be understood that method 600 may further include additional blocks not shown and/or omit some shown blocks, and the scope of the present disclosure is not limited in this regard.

As shown in FIG. 6, at block 610, the first device 110 determines whether a first condition related to Small Data Transmission (SDT) is met. The first condition may be used for determining which identifier, e.g., I-RNTI, is to be used for SDT.

In some example embodiments, the first condition may comprise the type of the SDT to be performed with the second device 120 being a predetermined type.

In some example embodiments, the first condition may comprise the type of the SDT to be performed being a CG-based SDT. For example, it may be specified for the first device 110 that the short I-RNTI is used to perform the CG-based SDT regardless of the indication for using the full I-RNTI from the second device 120, for example, the presence of the flag “useFullResumeID” in SIB1. In other words, the first device 110 may ignore the network's indication.

In these embodiments, the first condition may comprise the SDT to be performed on a cell 102 provided by a last serving network device for the first device with a configured CG. In this case, the second device 120 serves as the last serving RAN node of the first device 110.

In some example embodiments, the first condition may comprise the SDT to be performed on a cell which provides for the first device with a RRC Release with suspend.

In some example embodiments, the first condition may comprise the SDT to be performed on a cell which commands the first device to transition to RRC_INACTIVE state. If the first condition is met, the target identifier may be determined to be the short I-RNTI, or an I-RNTI shorter than the short I-RNTI.

In some example embodiments, the first condition may comprise one of the following:
the SDT to be performed on a first cell other than a second cell commands the first device 110 to transition to RRC_INACTIVE state, or
a type of the SDT to be performed being different from the CG-based SDT, in the above cases, if the first condition is met, the target identifier may be determined to be the full I-RNTI.

In some example embodiments, the first condition may comprise the type of the SDT to be performed being one of the following:
a 4-step Random Access Channel (RACH) based SDT, and in this case, the first message comprises a MSG3, or
a 2-step Random Access Channel (RACH) based SDT, and in this case, the first message comprises a MSGA.

In the embodiments where the type of the SDT is RACH based SDT, the first condition may further comprise the SDT to be performed on a cell 102 provided by a last serving network device for the first device. In this case, the second device 120 serves as the last serving RAN node of the first device 110. Alternatively, the first condition may further comprise the SDT to be performed an RNA associated with the inactive state of the first device 110.

In some example embodiments, the first condition may comprise a third message received from the second device 120 indicating the target identifier other than the full I-RNTI configured for the SDT, and the third message may be one of a RRC message (e.g., RRCRelease message, etc.) or a SIB. For example, the second device 120 may indicate whether the short I-RNTI can be used by the first device 110 in the RRCRelease message suspending the first device 110.

In some example embodiments, the first condition may comprise a fourth message received from the second device 120 indicating a field in a SIB to be ignored in determining the target identifier, and the field indicates a full I-RNTI to be used for the SDT. In these example embodiments, the fourth message may be the SIB. For example, the second device 120 may indicate whether the first device 110 should respect the “use FullResumeID” flag in the SIB1.

If the first condition is met, at block 620, the first device 110 determines a target identifier associated with an inactive state of the first device.

In some example embodiments, prior to determining the target identifier, the first device 110 may receive, from the second device 120, an indication of a first identifier associated with an inactive state of the first device to be used. The indication may comprise a field in a SIB from the second device 120, and the field indicates the usage of the first identifier for the first device 110 in the inactive state. The field may be the flag “useFullResumeID” in SIB. For example, the presence of the flag “useFullResumeID” may indicate the full-RNTI is to be used for resuming connection, and the absence of the flag may indicate the short-RNTI is to be used for resuming connection. It should be understood that any other indication from the network is also applicable to the example embodiments.

The target identifier may comprise, for example, one of a full I-RNTI, a short I-RNTI or an I-RNTI shorter than the short I-RNTI. In some example embodiments, the I-RNTI shorter than the short I-RNTI may be a new I-RNTI defined for CG-SDT. The second device 120 may configure certain CG-SDT resources only for a certain number of terminal devices, and therefore the identifier can be shorter while the second device 120 is still able to identify the terminal device 110 from the used CG-SDT resources and the shortened identifier.

In some example embodiments, to determine the target identifier, the first device 110 may further receive, from the second device 120, a second message comprising information for determining the target identifier. For example, the information for determining the target identifier may indicate a first identifier (e.g., the full I-RNTI, the short I-RNTI or the like) based on which the target identifier is determined. Additionally, the information for determining the target identifier may further indicate a rule for determining the target identifier from the first identifier. By way of example, the information for determining the target identifier may indicate a configuration of the target identifier. By way of another example, the information may indicate how many and/or which bits from the first I-RNTI the first device 110 should use for the CG-SDT, such as, x number of right most bits or y number of left most bits, etc. The number of bits may be from zero to a max number of full I-RNTI bits.

At block 630, the first device 110 transmits, to the second device 120, a first message for the SDT comprising the target identifier in the inactive state. The first message may comprise one of an RRCResumeRequest, a RRCResumeRequest1, or a further RRCResumeRequest for carrying an I-RNTI shorter than a short I-RNTI.

In the embodiments where the short I-RNTI is determined to be used, the first device 110 may transmit the RRCResumeRequest, rather than the RRCResumeRequest1, for CG-SDT regardless of the indication for using the full I-RNTI from the second device 120. Likewise, in the embodiments where the I-RNTI shorter than the short I-RNTI is determined to be used, the first device 110 may transmit the further RRCResumeRequest for carrying the shorter I-RNTI.

In some example embodiments, it may be preconfigured that the RRCResumeRequest1 is not applicable to CG-SDT. In this case new RRC message is defined for CG-SDT.

According to the example embodiments, there is provided a solution for SDT. Through the solution, the control information in RRC message used for initial SDT transmission can be shortened, while the network device is still able to uniquely identify the terminal device. In this way, more SDT data belonging to SRB or DRB configured for SDT can be included in the initial SDT transmission.

FIG. 7 illustrates a flowchart of a method 700 for small data transmission at a network device according to example embodiments of the present disclosure. The method 700 can be implemented at the second device 120 shown in FIG. 1. For the purpose of discussion, the method 700 will be described with reference to FIG. 1. It is to be understood that method 700 may further include additional blocks not shown and/or omit some shown blocks, and the scope of the present disclosure is not limited in this regard.

As shown in FIG. 7, at block 710, the second device 120 receives, from the first device 110, a first message SDT comprising a target identifier associated with an inactive state of the first device 110. The target identifier is determined by the first device 110 in accordance with a first condition related to SDT being met. The target identifier may comprise one of a full I-RNTI, a short I-RNTI or an I-RNTI shorter than the short I-RNTI.

In some example embodiments, the first message comprises one of an RRCResumeRequest, a RRCResumeRequest1, or a further RRCResumeRequest for carrying an I-RNTI shorter than a short I-RNTI.

In the embodiments where the short I-RNTI is used, the second device 120 may receive the RRCResumeRequest, rather than the RRCResumeRequest1, for CG-SDT regardless of the indication for using the full I-RNTI from the second device 120. Likewise, in the embodiments where the I-RNTI shorter than the short I-RNTI is used, the second device 120 may receive the further RRCResumeRequest for carrying the shorter I-RNTI.

In some example embodiments, it may be preconfigured that the RRCResumeRequest1 is not applicable to CG-SDT.

In some example embodiments, the first condition may comprise a type of the SDT to be performed being a predetermined type of the SDT.

In some example embodiments, the type of the SDT may comprise a CG-based SDT, and the second device 120 may comprise a last serving network device for the first device 110. In these embodiments, the second device 120 may configure the first device 110 with a CG configuration. Since the second device 120 may only configure CG-SDT resources for a certain number of terminal devices including the first device 110, the identifier can be shorter than a full-RNTI while the second device 120 is still able to identify the first device 110 and network device from the CG-SDT resources and shortened identifier. A new RRC message may be defined for the CG-SDT.

In some example embodiments, the type of the SDT may comprise a 4-step Random Access Channel (RACH) based SDT, and the first message may comprise a MSG3. Alternatively, the type of the SDT may comprise a 2-step Random Access Channel (RACH) based SDT, and the first message may comprise a MSGA. In the embodiments where the type of the SDT is RACH-based SDT, the second device 120 may comprise a last serving network device for the first device 110, or alternatively, the second device 120 may be located within an RNA associated with the inactive state of the first device 110.

In some example embodiments, the first condition may comprise the SDT to be performed on a cell which commands the first device 110 to transition to the inactive state. In this case, the target identifier may comprise one of the short I-RNTI, or an I-RNTI shorter than the short I-RNTI.

In some example embodiments, the first condition may comprise the SDT to be performed on a first cell other than a second cell commands the first device 110 to transition to the inactive state. In this case, the target identifier may comprise the full I-RNTI.

In some example embodiments, the first condition may comprise a type of the SDT to be performed being different from the CG-based SDT. In this case, the target identifier may comprise the full I-RNTI.

In some example embodiments, prior to receipt of the first message, the second device 120 may transmit, to the first device 110, an indication of a first identifier associated with an inactive state of the first device 110 to be used. The indication may comprise a field in a SIB from the second device 120, and the field indicates the first identifier to be used by the first device 110 in the inactive state. The field may be the flag “useFullResumeID” in SIB. For example, the presence of the flag “useFullResumeID” may indicate that the full-RNTI is to be used for resuming connection, and the absence of the flag may indicate that the short-RNTI is to be used for resuming connection. It should be understood that any other indication from the network is also applicable to the example embodiments.

In some example embodiments, the second device 120 may transmit, to the first device 110, a second message comprising information for determining the target identifier by the first device 110. For example, the information for determining the target identifier may indicate a first identifier (e.g., the full I-RNTI, the short I-RNTI or the like) based on which the target identifier is determined.

Additionally, the information for determining the target identifier may further indicate a rule for determining the target identifier from the first identifier. By way of example, the information for determining the target identifier may indicate a configuration of the target identifier. By way of another example, the information may indicate how many and/or which bits from the first I-RNTI the first device 110 should use for the CG-SDT, such as, x number of right most bits or y number of left most bits, etc. The number of bits may be from zero to a max number of full I-RNTI bits.

In some example embodiments, the second device 120 may transmit, to the first device 110, a third message indicating the target identifier other than a full I-RNTI configured for the SDT. The third message may comprise one of a RRC message (e.g., RRCRelease message, etc.) or a SIB. For example, the second device 120 may indicate whether the short I-RNTI can be used by the first device 110 in the RRCRelease message suspending the first device 110.

In some example embodiments, the second device 120 may transmit, to the first device 110, and a fourth message may indicate a field in a SIB to be ignored in determining the target identifier, and the field indicates a full I-RNTI to be used for the SDT. In these example embodiments, the fourth message may be the SIB. For example, the second device 120 may indicate whether the first device 110 should respect the “useFullResumeID” flag in the SIB1.

According to the example embodiments of the present disclosure, there is provided an enhanced SDT mechanism. Such a mechanism is beneficial for the CG-based SDT and RACH-based SDT, as the SDT operations are only permitted within the same serving cell or RNA. Since the short I-RNTI is sufficient to identify the UE in the inactive state within the coverage of its serving gNB, all the information encoded in the full I-RNTI may not be needed. By using the short I-RNTI, or even a shorter I-RNTI, instead of the full I-RNTI, and thus using an RRCResumeRequest of 48 bits instead of RRCResumeRequest1 of 64 bits, bits are saved and used for UL data that can be transmitted while respecting the maximum SDT data threshold configured by the network. As such, the SDT procedure between the UE and the base station is enhanced.

In some example embodiments, a first apparatus capable of performing any of the method 600 (for example, the first device 110) may comprise means for performing the respective steps of the method 600. The means may be implemented in any suitable form. For example, the means may be implemented in a circuitry or software module.

In some example embodiments, the first apparatus comprises: means for in accordance with a determination that a first condition related to Small Data Transmission (SDT) is met, determining a target identifier associated with an inactive state of the first apparatus; and means for transmitting, to the second device, a first message for the SDT comprising the target identifier in the inactive state.

In some example embodiments, the first condition comprises a type of the SDT to be performed being a predetermined type of the SDT.

In some example embodiments, the first condition comprises the type of the SDT to be performed being a configured grant (CG) based SDT.

In some example embodiments, the first condition further comprises the SDT to be performed on a cell provided by a last serving network device for the first apparatus with a CG configuration.

In some example embodiments, the first condition comprises the SDT to be performed on a cell which provides for the first device with a RRC Release with suspend.

In some example embodiments, the first condition comprises the SDT to be performed on a cell which commands the first device to transition to the inactive state.

In some example embodiments, the target identifier is determined to be one of a short Inactive Radio Network Temporary Identifier (I-RNTI), or an I-RNTI shorter than the short I-RNTI.

In some example embodiments, the first condition comprises one of the following: the SDT to be performed on a first cell other than a second cell commands the first device to transition to the inactive state, or a type of the SDT to be performed being different from a configured grant (CG) based SDT. The target identifier is determined to be a full Inactive Radio Network Temporary Identifier (I-RNTI).

In some example embodiments, the first condition additionally or alternatively comprises the SDT type to be performed on the same cell where CG SDT was configured for the first device. In some example embodiments, the first condition additionally or alternatively comprises the SDT type to be performed on the same cell where the first device was transitioned to RRC_INACTIVE (or the RRC connection of the UE was suspended).

In some example embodiments, the first condition additionally or alternatively comprises the SDT type to be performed on the current RNA.

In some example embodiments, the first condition comprises the type of the SDT to be performed being one of the following: a 4-step Random Access Channel (RACH) based SDT, and the first message comprising a MSG3, or a 2-step Random Access Channel (RACH) based SDT, and the first message comprising a MSGA.

In some example embodiments, t the first condition further comprises the SDT to be performed on one of the following: a cell provided by a last serving network device for the first apparatus, or a radio access network notification area (RNA) associated with the inactive state of the first apparatus.

In some example embodiments, the first apparatus further comprises: means for prior to determining the target identifier, receiving, from the second device, an indication of a first identifier associated with an inactive state of the first apparatus to be used.

In some example embodiments, the indication comprises a field in a system information block (SIB) from the second device, the field indicates the first identifier to be used by the first apparatus in the inactive state.

In some example embodiments, the target identifier comprises one of a full Inactive Radio Network Temporary Identifier (I-RNTI), a short I-RNTI or an I-RNTI shorter than the short I-RNTI.

In some example embodiments, the means for determining the target identifier comprises: means for receiving, from the second device, a second message comprising information for determining the target identifier.

In some example embodiments, information for determining the target identifier indicates a first identifier based on which the target identifier is determined.

In some example embodiments, information for determining the target identifier further indicates a rule for determining the target identifier from the first identifier.

In some example embodiments, information for determining the target identifier indicates a configuration of the target identifier.

In some example embodiments, the first condition further comprises a third message received from the second device indicating the target identifier other than a full Inactive Radio Network Temporary Identifier (I-RNTI) configured for the SDT, and the third message comprises one of a Radio Resource Control (RRC) message or a system information block (SIB).

In some example embodiments, the first condition further comprises a fourth message received from the second device indicating a field in a system information block (SIB) to be ignored in determining the target identifier, the field indicates a full Inactive Radio Network Temporary Identifier (I-RNTI) to be used for the SDT, and the fourth message comprises the SIB.

In some example embodiments, the first message comprises one of a RRCResumeRequest, a RRCResumeRequest1, or a further RRCResumeRequest for carrying an I-RNTI shorter than a short I-RNTI.

In some example embodiments, the first apparatus comprises a terminal device, and the second device comprises a network device.

In some example embodiments, a second apparatus capable of performing any of the method 700 (for example, the second device 120) may comprise means for performing the respective steps of the method 700. The means may be implemented in any suitable form. For example, the means may be implemented in a circuitry or software module.

In some example embodiments, the second apparatus comprises: means for receiving, from a first device, a first message for Small Data Transmission (SDT) comprising a target identifier associated with an inactive state of the first device, the target identifier determined by the first device in accordance with a first condition related to SDT being met; and means for identifying the first device based on the target identifier.

In some example embodiments, the type of the SDT comprises a configured grant (CG) based SDT, and the second apparatus further comprises: means for configure the first device with a CG configuration.

In some example embodiments, the first condition comprises a type of the SDT to be performed being a predetermined type of the SDT.

In some example embodiments, the type of the SDT comprises one of the following: a 4-step Random Access Channel (RACH) based SDT, and the first message comprising a MSG3, or a 2-step Random Access Channel (RACH) based SDT, and the first message comprising a MSGA, and the second apparatus comprises a last serving network device for the first device, or located within a radio access network notification area (RNA) associated with the inactive state of the first device.

In some example embodiments, the first condition comprises the SDT to be performed on a cell which commands the first device to transition to the inactive state, and the target identifier comprises one of a short Inactive Radio Network Temporary Identifier (I-RNTI), or an I-RNTI shorter than the short I-RNTI.

In some example embodiments, the first condition comprises the SDT to be performed on a first cell other than a second cell commands the first device to transition to the inactive state, and the target identifier comprises a full Inactive Radio Network Temporary Identifier (I-RNTI).

In some example embodiments, the first condition comprises a type of the SDT to be performed being different from a configured grant (CG) based SDT, and the target identifier comprises a full Inactive Radio Network Temporary Identifier (I-RNTI).

In some example embodiments, the second apparatus further comprises means for prior to receipt of the first message, transmitting, to the first device, an indication of a first identifier associated with an inactive state of the first device to be used.

In some example embodiments, the indication comprises a field in a system information block (SIB), and the field indicates the first identifier to be used by the first device in the inactive state.

In some example embodiments, the target identifier comprises one of a full Inactive Radio Network Temporary Identifier (I-RNTI), a short I-RNTI or an I-RNTI shorter than the short I-RNTI.

In some example embodiments, the second apparatus further comprises: means for transmitting, to the first device, a second message comprising information for determining the target identifier by the first device.

In some example embodiments, information for determining the target identifier indicates a first identifier based on which the target identifier is determined.

In some example embodiments, information for determining the target identifier further indicates a rule for determining the target identifier from the first identifier.

In some example embodiments, information for determining the target identifier indicates a configuration of the target identifier.

In some example embodiments, the second apparatus further comprises: means for transmitting, to the first device, a third message indicating the target identifier other than a full Inactive Radio Network Temporary Identifier (I-RNTI) configured for the SDT, the third message comprising one of a Radio Resource Control (RRC) message or a system information block (SIB).

In some example embodiments, the second apparatus further comprises: means for transmitting, to the first device, a fourth message indicating a field in a system information block (SIB) to be ignored in determining the target identifier by the first device, the field indicating a full Inactive Radio Network Temporary Identifier (I-RNTI) to be used for the SDT, and the fourth message comprising the SIB.

In some example embodiments, the first message comprises one of a RRCResumeRequest, a RRCResumeRequest1, or a further RRCResumeRequest for carrying an I-RNTI shorter than a short I-RNTI.

In some example embodiments, the first device comprises a terminal device, and the second apparatus comprises a network device.

According to an embodiment, the target identifier is indicated with a number of bits. Said number may be a non-zero value.

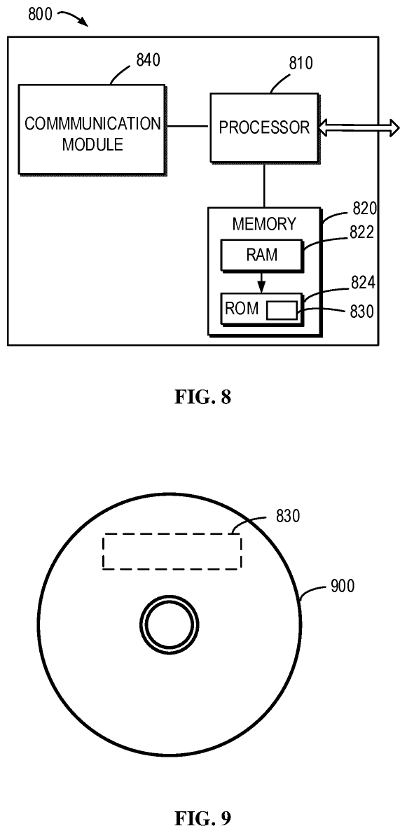

FIG. 8 is a simplified block diagram of a device 800 that is suitable for implementing embodiments of the present disclosure. The device 800 may be provided to implement the communication device, for example the first device 110 or the second device 120 as shown in FIG. 1. As shown, the device 800 includes one or more processors 810, one or more memories 820 coupled to the processor 810, and one or more transmitters and receivers (TX/RX) 840 coupled to the processor 810.

The TX/RX 840 is for bidirectional communications. The TX/RX 840 has at least one antenna to facilitate communication. The communication interface may represent any interface that is necessary for communication with other network elements.

The processor 810 may be of any type suitable to the local technical network and may include one or more of the following: general purpose computers, special purpose computers, microprocessors, digital signal processors (DSPs) and processors based on multicore processor architecture, as non-limiting examples. The device 800 may have multiple processors, such as an application specific integrated circuit chip that is slaved in time to a clock which synchronizes the main processor.

The memory 820 may include one or more non-volatile memories and one or more volatile memories. Examples of the non-volatile memories include, but are not limited to, a Read Only Memory (ROM) 824, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 822 and other volatile memories that will not last in the power-down duration.

A computer program 830 includes computer executable instructions that are executed by the associated processor 810. The program 830 may be stored in the ROM 820. The processor 810 may perform any suitable actions and processing by loading the program 830 into the RAM 820.

The embodiments of the present disclosure may be implemented by means of the program 830 so that the device 800 may perform any process of the disclosure as discussed with reference to FIGS. 3-7. The embodiments of the present disclosure may also be implemented by hardware or by a combination of software and hardware.

In some embodiments, the program 830 may be tangibly contained in a computer readable medium which may be included in the device 800 (such as in the memory 820) or other storage devices that are accessible by the device 800. The device 800 may load the program 830 from the computer readable medium to the RAM 822 for execution. The computer readable medium may include any types of tangible non-volatile storage, such as ROM, EPROM, a flash memory, a hard disk, CD, DVD, and the like. FIG. 9 illustrates an example of the computer readable medium 900 in form of CD or DVD. The computer readable medium has the program 830 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, device, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the methods 600 and 700 as described above with reference to FIGS. 6-7. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing device, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, device or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, device, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. A first device comprising:
at least one processor; and
at least one memory including computer program codes;
the at least one memory and the computer program codes are configured to, with the at least one processor, cause the first device at least to:
in accordance with a determination that a first condition related to Small Data Transmission (SDT) is met, determine a target identifier associated with an inactive state of the first device; and
transmit, to the second device, a first message for the SDT comprising the target identifier in the inactive state.

2. The first device of claim 1, wherein the first condition comprises a type of the SDT to be performed being a predetermined type of the SDT.

3. The first device of claim 1, wherein the first condition comprises a type of the SDT to be performed being a configured grant (CG) based SDT.

4. The first device of claim 1 wherein the first condition comprises the SDT to be performed on a cell provided by a last serving network device for the first device with a CG configuration.

5. The first device of claim 1, wherein the first condition comprises the SDT to be performed on a cell which provides for the first device with a RRC Release with suspend.

6. The first device of claim 1, wherein the first condition comprises the SDT to be performed on a cell which commands the first device to transition to the inactive state.

7. The first device of claim 6, wherein the target identifier is determined to be one of a short Inactive Radio Network Temporary Identifier (I-RNTI), or an I-RNTI shorter than the short I-RNTI.

8. The first device of claim 1, wherein the first condition comprises one of the following:
the SDT to be performed on a first cell other than a second cell commands the first device to transition to the inactive state, or
a type of the SDT to be performed being different from a configured grant (CG) based SDT, and
wherein the target identifier is determined to be a full Inactive Radio Network Temporary Identifier (I-RNTI).

9. The first device of claim 1, wherein the first condition comprises a type of the SDT to be performed being one of the following:
a 4-step Random Access Channel (RACH) based SDT, and the first message comprising a MSG3, or
a 2-step Random Access Channel (RACH) based SDT, and the first message comprising a MSGA.

10. The first device of claim 1, wherein the first condition further comprises the SDT to be performed on one of the following:
a cell provided by a last serving network device for the first device, or
a radio access network notification area (RNA) associated with the inactive state of the first device.

11. The first device of claim 1, wherein the at least one memory and the computer program codes are configured to, with the at least one processor, further cause the first device to:
prior to determining the target identifier, receive, from the second device, an indication of a first identifier associated with an inactive state of the first device to be used.

12. The first device of claim 11 wherein the indication comprises a field in a system information block (SIB) from the second device, the field indicates the first identifier to be used by the first device in the inactive state.

13. The first device of claim 1, wherein the target identifier comprises one of a full Inactive Radio Network Temporary Identifier (I-RNTI), a short I-RNTI or an I-RNTI shorter than the short I-RNTI.

14. The first device of claim 1, wherein the at least one memory and the computer program codes are configured to, with the at least one processor, further cause the first device to determine the target identifier by:
receiving, from the second device, a second message comprising information for determining the target identifier.

15. The first device of claim 14, wherein information for determining the target identifier indicates a first identifier based on which the target identifier is determined.

16. The first device of claim 15, wherein information for determining the target identifier further indicates a rule for determining the target identifier from the first identifier.

17. The first device of claim 14, wherein information for determining the target identifier indicates a configuration of the target identifier.

18. The first device of claim 1, wherein the first condition further comprises a third message received from the second device indicating the target identifier other than a full Inactive Radio Network Temporary Identifier (I-RNTI) configured for the SDT, and the third message comprises one of a Radio Resource Control (RRC) message or a system information block (SIB).

19-21. (canceled)

22. A second device comprising:
at least one processor, and
at least one memory including computer program codes;
the at least one memory and the computer program codes are configured to, with the at least one processor, cause the second device at least to:
receive, from a first device, a first message for Small Data Transmission (SDT) comprising a target identifier associated with an inactive state of the first device, the target identifier determined by the first device in accordance with a first condition related to SDT being met; and
identify the first device based on the target identifier.

23-39. (canceled)

40. A method comprising:
in accordance with a determination that a first condition related to Small Data Transmission (SDT) is met, determining, at a first device, a target identifier associated with an inactive state of the first device; and
transmitting, to the second device, a first message for the SDT comprising the target identifier in the inactive state.

41-45. (canceled)
